(19) United States
(12) Patent Application Publication
(10) Pub. No.: US 2024/0207737 A1
(43) Pub. Date: Jun. 27, 2024

(54) DIRECTING IN-GAME MODE FOR FIRST CLIENT DEVICE USING SECOND CLIENT DEVICE

(71) Applicant: GOOGLE LLC, Mountain View, CA (US)

(72) Inventors: Leon Bayliss, Redwood City, CA (US); Philip George Nichols Lamoureux, San Francisco, CA (US)

(21) Appl. No.: 18/557,134

(22) PCT Filed: May 6, 2021
(86) PCT No.: PCT/US2021/031111

§ 371 Date: Oct. 25, 2023

(51) Int. Cl. A63F 13/5255; A63F 13/211; A63F 13/26; A63F 13/355

(52) U.S. Cl. CPC A63F 13/5255; A63F 13/211; A63F 13/26; A63F 13/355

(57) ABSTRACT

Gaming content for a game session is provided to a first client device associated with a user, the game session operating in a first mode of operation. An indication is received that the game session on the first client device has initiated a second mode of operation. Based on the initiation of the second mode, the game session operating in the second mode is initiated on a second client device associated with the user. An interface element is presented in the game session on the first client device to facilitate a connection with the second client device, which may then be used to control aspects of operations in the second mode.

### BACKGROUND

“Cloud gaming” or “game streaming” typically involves executing a video gaming application on one or more remote servers and providing the resulting video and audio content as a video stream and audio stream, respectively, that is transmitted over one or more networks to a user's client device. By utilizing at least one remote server (i.e., “the cloud”) to perform some or all aspects of the associated tasks of graphics rendering, video capture, video encoding, and video streaming, a user may run performance-taxing gaming applications without using a high-end hardware client device. Instead, the user may typically need only a display screen, a device capable of playing a video stream, and one or more user input devices.

Video game systems (such as cloud gaming systems, game consoles, and personal computers) allow a user (alternatively referred to as a player) to interact with a virtual environment generated by a gaming application. The user interacts with the gaming application by providing inputs via a game controller or other input device and, in response to those user inputs, the gaming application modifies a game state associated with the game. Based on the game content, the gaming application changes the aspects of the virtual environment displayed for the user. Thus, through a series of inputs that alter the game state, the user plays the game associated with the gaming application.

### BRIEF SUMMARY OF EMBODIMENTS

Embodiments are described herein in which gaming content for a first game session is provided to a first client device associated with a user, the game session operating in a first mode of operation. An indication is received that the game session on the first client device has initiated a second mode of operation. Based on the initiation of the second mode, the game session operating in the second mode is initiated on a second client device associated with the user. An interface element is presented in the game session on the first client device for connecting with the second client device, which may then be used to control aspects of operations in the second mode. The interface element presented in the first game session may, for example, enable (upon a user acting on the interface element) a connection of the first client device with the second client device and/or a connection of the second client device with a server streaming real-time content associated with the game session for initiating the game session on the second client device.

In certain embodiments, a method may comprise providing gaming content for a first game session to a first client device associated with a user, the game session operating in a first mode of operation; receiving an indication that the game session on the first client device has initiated a second mode of operation; and, based at least in part on the indicated initiation of the second mode, initiating the game session on a second client device associated with the user, the game session operating in the second mode.

The method may further comprise providing, responsive to the initiating of the second mode of operation, one or more interface elements in the game session on the first client device for connecting with the second client device. The one or more interface elements may include a first interface element to be photographically captured by the second client device. The first interface element may be one or more of a group that includes a machine-readable optical label, a barcode, and a Quick Response (QR) code.

Providing the game session on the first client device may include streaming real-time content associated with the game session from one or more servers to the first client device, and initiating the game session on the second client device may include streaming real-time content associated with the game session from the one or more servers to the second client device.

The first mode may comprise user gameplay via a gaming application, and the second mode may comprise a photographic mode to facilitate a capture of one or more images from the user gameplay. Operations in the second mode may include adjusting one or more aspects of a virtual camera in a game world, the one or more aspects, for example, including at least one of a group that includes a position of a virtual camera in the game world, an orientation of the virtual camera in the game world, and a lighting parameter for the virtual camera in the game world. Adjusting the one or more aspects of the virtual camera may include adjusting the position of the virtual camera based on a position of the second client device, for example based on a (relative) position of the second client device relative to first client device and/or a user of the second client device. Adjusting the one or more aspects of the virtual camera may include adjusting the orientation of the virtual camera based on an orientation of the second client device, for example based on a (relative) position of the second client device relative to first client device and/or a user of the second client device.

In certain embodiments, the proposed solution may allow for enabling or transferring control of one or more game session related aspects on/to a second client device after having initiated and thus, for example, switched to the second mode of operation. This for example includes that a gameplay of the game session is paused when initiating the second mode of operation and that one or more aspects of a virtual camera in a game world of the (paused) game session may then by controlled by the second client device, for example by tilting, rotating, or moving the second client device within the physical space proximate to the player. Temporary control by the second client device may then terminate upon switching back from the second mode of operation to the first mode of operation. In an exemplary embodiment, after a corresponding return to the first mode of operation, the game session may be automatically resumed on the first client device with the one or more aspects of the game world in a state prior to initiating the game session on the second client device. A player may thus resume gameplay with the first client device in an original state set before a pause, and thus (as one example) with original aspects of a virtual camera, after having captured one or more images with one or more (temporarily) changed aspects of the virtual camera using the second client device. This may, for example, provide for a more convenient and comfortable possibility to capture images from user gameplay in cloud gaming and thus to direct in-game photography.

Initiating the game session on the second client device may include presenting content generated via the gaming application that is being displayed on a display of the first client device on a display of the second client device.

In certain embodiments, a server may comprise a network interface; one or more processors; and a memory storing a set of executable instructions. The set of executable instructions may be to manipulate the one or more processors to provide gaming content for a first game session to a first client device associated with a user, the game session operating in a first mode of operation; to receive an indication that the game session on the first client device has initiated a second mode of operation; and, based at least in part on the indicated initiation of the second mode, to initiate the game session on a second client device associated with the user, the game session operating in the second mode.

The set of executable instructions may further be to manipulate the one or more processors to provide, responsive to initiating the second mode of operation, one or more interface elements in the game session on the first client device to allow and thus facilitate a connection with the second client device. The one or more interface elements may include a first interface element to be photographically captured by the second client device. The first interface element may be one or more of a group that includes a machine-readable optical label, a barcode, and a QR code.

To provide the game session on the first client device may include to stream real-time content associated with the game session from the server to the first client device, and to initiate the game session on the second client device may include to stream real-time content associated with the game session from the server to the second client device.

The first mode may comprise user gameplay via a gaming application, and the second mode may comprise a photographic mode for capturing one or more images from the user gameplay. Operations in the second mode may include to adjust one or more aspects of a virtual camera in a game world, and the one or more aspects may comprise at least one of a group that includes a position of a virtual camera in the game world, an orientation of the virtual camera in the game world, and a lighting parameter for the virtual camera in the game world. To adjust the one or more aspects of the virtual camera may include to adjust the position of the virtual camera based on a position of the second client device. To adjust the one or more aspects of the virtual camera may include to adjust the orientation of the virtual camera based on a orientation of the second client device.

In certain embodiments, a non-transitory computer-readable medium may store a set of executable instructions, the set of executable instructions to manipulate at least one processor to provide gaming content for a first game session to a first client device associated with a user, the game session operating in a first mode of operation; to receive an indication that the game session on the first client device has initiated a second mode of operation; and, based at least in part on the indicated initiation of the second mode, to initiate the game session on a second client device associated with the user, the game session operating in the second mode.

The set of executable instructions may further be to manipulate the at least one processor to provide, responsive to initiating the second mode of operation, one or more interface elements in the game session on the first client device to facilitate a connection with the second client device. The one or more interface elements may include one or more of a group that includes a machine-readable optical label, a barcode, and a QR code. To provide the game session on the first client device may include to stream real-time content associated with the game session from one or more servers to the first client device, and to initiate the game session on the second client device may include to stream real-time content associated with the game session from the one or more servers to the second client device.

The first mode may comprise user gameplay via a gaming application, and the second mode may comprise a photographic mode for capturing one or more images from the user gameplay.

Operations in the second mode of operation may include adjusting one or more aspects of a virtual camera in a game world, the one or more aspects including at least one of a group that includes a position of a virtual camera in the game world, an orientation of the virtual camera in the game world, and a lighting parameter for the virtual camera in the game world.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a cloud gaming system facilitating single- and multi-player gaming in accordance with one or more embodiments.

FIG. 2 illustrates an example gaming graphical user interface of a game session operating in a first mode in accordance with one or more embodiments.

FIG. 3 illustrates an example gaming graphical user interface of a game session operating in a second mode in accordance with one or more embodiments.

FIG. 4 is a block diagram illustrating an overview of an operational routine of a processor-based cloud gaming server system in accordance with one or more embodiments.

FIG. 5 is a component-level block diagram illustrating an example cloud gaming server computing system configured for executing techniques described herein in accordance with one or more embodiments.

### DETAILED DESCRIPTION

In many modern gaming applications, a user of the gaming application (the player) may elect to pause typical gameplay operations in a first gaming mode of operations, such as traversing a game world and interacting with entities within that game world, to enter a second mode of operations (often called a “photographic mode,” “photo mode,” or similar term) in which the player may capture one or more still images (also known as a screenshot) from the gaming application, such as to preserve images of gameplay for later retrieval and display. Typically, such images may be used for informational purposes, social exchange, or artistic use.

In certain scenarios and embodiments, this second photographic mode may provide the player (referenced interchangeably herein with “user” unless context clearly dictates otherwise) with greater options for generating a still image of their gameplay than simply capturing a screenshot of that gameplay as it would normally be presented in the first gameplay mode. For example, in certain gaming applications, once the second photographic mode is initiated the player may be provided with options to adjust certain aspects of the image displayed by the gaming application without otherwise affecting gameplay operations in the first mode. As non-limiting examples, in various gaming applications and embodiments operations in the second photographic mode may include to alter or remove certain user interface (UI) elements (e.g., a “health bar” or other UI element associated with a player's state in the game world), to adjust a position or orientation of a virtual camera within the game world, to adjust a position or orientation of the player's character within the game world, and/or to adjust one or more lighting parameters (e.g., exposure, depth of field, focus, lens flare, ambient lighting, lighting hue, etc.) associated with the still image being generated by the gaming application.

Previous approaches for enabling user inputs to make such adjustments within a photographic mode of a gaming application utilize the same user input device or devices as those used by the player to interact with the game world during the first gameplay mode—that is, the player may adjust a position or orientation of a virtual camera in the game world during the photographic mode with the same gaming controller or other input device as the player uses to interact with the game world during the first gameplay mode.

Embodiments of techniques presented herein enable a user to initiate multiple gameplay sessions on multiple client devices in order to utilize a second client device to control various parameters of a gaming application operating in a second photographic mode of operations. In certain embodiments, the control of parameters in the second photographic mode of operations does not permanently affect the game application parameters so that the game application may be resumed in the first gameplay mode with the parameters set as before switching to the second photographic mode. In certain embodiments, the second client device may be a mobile computing device with various sensors and facilities for translating user interactions with the second client device into operations of the second photographic mode. Moreover, certain embodiments of the described techniques may, in response to detecting that a first game session on a first gaming client device has initiated operations in a second mode (e.g., a photographic mode), autonomously provide one or more UI elements for initiating the game session on a second gaming client device, such as to enable the player to use additional input facilities of the second gaming client device to control one or more aspects of the game session. In certain embodiments, a remote server or first client device that is generating the game session via the gaming application operating in the second photographic mode may provide one or more UI elements to allow for such gestures or other interactions with the second client device. In certain embodiments, the first client device is a standalone device integrating or being coupled to at least one display, such as a personal computer (PC) or game console, whereas the second client device is a mobile device allowing control of one or more aspects of a virtual camera in the second mode of operation

As one example, in various embodiments gyroscopic and accelerometer sensors within the second client device may enable the user to adjust a position or orientation of the virtual camera within the game world by making corresponding adjustments to a position or orientation of the second client device itself—that is, by tilting, rotating, or moving the second client device within the physical space proximate to the player. In certain embodiments, the user may then physically travel within that physical space in order to make such adjustments, enabling the user to virtually “walk around” in the game world in order to configure a perspective for the still image they wish to capture.

As another example, in certain embodiments a touch-enabled display of the second client device may be utilized to adjust various lighting or photographic parameters associated with the still image to be generated by the gaming application operating in the second photographic mode. For example, a user may tap on the touch-enabled display to indicate a point of focus desired for the still image; may perform one or more gestures with respect to the touch-enabled display to control a color tint of one or more ambient lighting for the still image; or may make various other adjustments to the still image using the touch-enabled display.

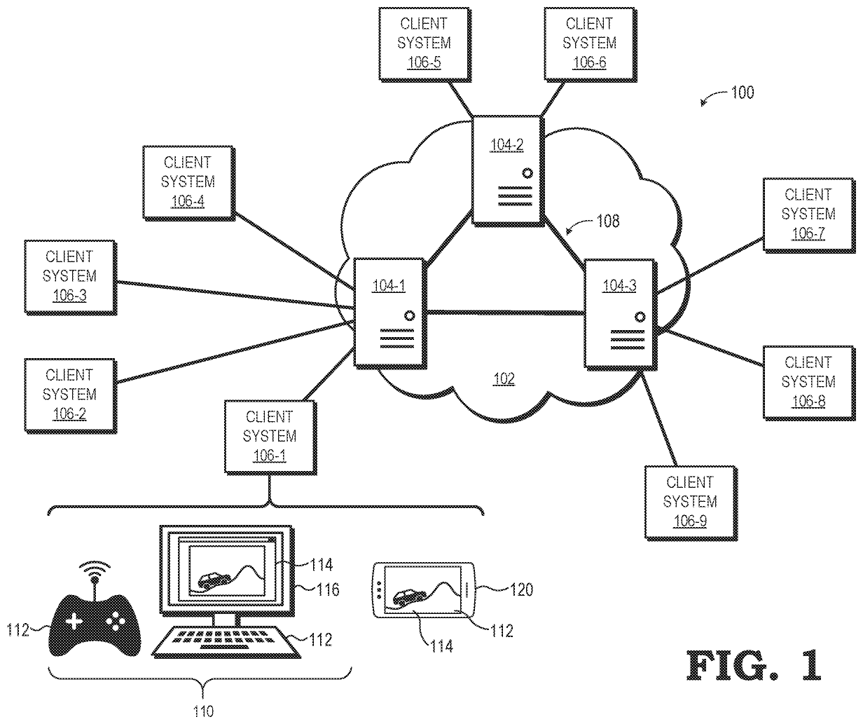

FIG. 1 is a block diagram illustrating a cloud gaming system 100 facilitating single-player and/or multiplayer (including massively multiplayer) gaming in accordance with at least one embodiment. The cloud gaming system 100 includes a cloud platform 102 having a plurality of servers 104 that are coupled to corresponding subsets of a plurality of client systems 106 via one or more networks, such as the Internet. The servers 104 are interconnected in the depicted embodiment via a high-bandwidth, low-latency inter-server messaging bus 108. The servers 104 typically are distributed in one or more data centers over a geographical area so as to reduce transmission latency through physical proximity. In the simplified example of FIG. 1, the cloud platform 102 includes three servers 104-1 to 104-3 supporting nine client systems 106-1 to 106-9, with client systems 106-1 to 106-4 served by server 104-1, client systems 106-5 and 106-6 served by server 104-2, and client systems 106-7 to 106-8 served by server 104-3. It will be appreciated that in a typical real-world implementation, the number of servers 104 and number of client systems 106 typically will be considerably higher.

In the depicted embodiment of FIG. 1, each server 104 operates to execute a corresponding game platform instance that facilitates execution of one or more game sessions of a gaming application for a corresponding player. That is, the game platform instance provides various resources, such as communication/network management, resource management, media rendering encoding, and the like, so as to simulate execution of a gaming application for a corresponding player as though that gaming application was being played on a local gaming device, such as a personal computer (PC) or game console. Each player game session thus represents execution, or simulation, of the gaming application for a corresponding player. To illustrate, a player instance can be considered to be a virtual game console; thus such instances are containers that enable a single game runtime including networking, rendering, audio and video encoding, streaming and receipt of user inputs for both single- and multi-player gaming applications.

Each client system 106 represents the hardware and software resources utilized to receive player input through manipulation of one or more input/output devices for at least one player, as well as to present the video and audio content representing the visual and auditory content, respectively, of the gameplay for the at least one player. Examples of a client system 106 include one or more desktop computers, notebook computers, tablet computers, a compute-enabled cellular phone (that is, a “smart phone”), a compute-enabled television (that is, a “smart TV”), and the like. As illustrated with reference to client system 106-1, each client system 106 includes one or more gaming client devices. In the depicted embodiment, the client system 106-1 comprises a first gaming client device 110, which is communicatively coupled to, or otherwise associated with, a display 116, at least one input device 112, one or more network interfaces to couple to the network connecting the client system 106 to the corresponding server 104, one or more processors, memory, storage, speakers, and other computing resources to process the incoming media streams as is well known in the art. The client system 106-1 further includes second gaming client device 120, which in the depicted embodiment is an integrated mobile computing device having input facilities, output facilities, and communication facilities analogous to those noted above with respect to the first gaming client device 110.

While certain aspects of embodiments described herein will be discussed with specific reference to cloud gaming scenarios, it will be appreciated that in certain embodiments the described techniques may be utilized in one or more local computing environments, such as if the gaming content is generated by a first local computing device (e.g., first gaming client device 110) locally executing a gaming application. That first local computing device may, in certain scenarios and embodiments, operate as a server of such generated gaming content to a second local computing device (e.g., second gaming client device 120). In certain embodiments, the first gaming client device 110 is therefore able to operate as a server of the generated gaming content to the second local computing device, even if such gaming content is provided to the second local computing device via one or more non-local networks and intervening remote servers.

During operations in a game streaming scenario, the client system 106 receives video and audio streams (not shown) generated from execution of a corresponding player game session at a corresponding server 104, and utilizes the compute, storage, and display resources of the first gaming client device 110 and/or the second gaming client device 120 for decoding and displaying the video frames of the transmitted video stream and for decoding and outputting the corresponding audio content. In some embodiments, the processing and display of video and audio content from the gaming application executed at the server 104 is facilitated by a software application executed by the first and/or second gaming client devices at the client system 106 (and represented in FIG. 1 by graphical user interface (GUI) 114). This software application can include, for example, a cloud-gaming-specific software application. In other embodiments, a more general software application is utilized, and the video stream and audio stream are formatted and transmitted by the server 104 to be compatible with this software application. For example, in one embodiment the client system 106 utilizes a web browser that utilizes a hypertext markup language (HTML) format for display of the video content represented by the video and output of the audio content represented by the associated audio stream, and the server 104 provides the video stream in a format and the audio stream in formats compatible with the HTML format for display via the web browser.

Being interactive, the executing player game session utilizes player input to at least partially direct the gameplay experience of a gaming session with the player. This player input is received at least in part through the input device 112, which comprises any of a variety of I/O devices or a combination thereof, such as a game controller, game pad, joystick, keyboard, mouse, touchpad, touchscreen, trackball, steering wheel or yoke, pedal, dance pad, simulated gun, optical motion tracker, inertial sensor, light/laser source and detector, and the like. In some embodiments, the input device 112 is communicatively coupled to one or more of the associated gaming client devices, such that player input data generated by a player's manipulation of the input device 112 is provided to the corresponding server 104 via the client system 106. To illustrate, in certain embodiments the input device 112 can be wired or wirelessly connected to the client system 106 such that all data output by the input device 112 is routed through a network interface between the client system 106 and the network connecting the client system 106 to the server 104. In other embodiments, the input device 112 has a separate, independent network connection with the corresponding server 104 via a network. For example, the cloud gaming system 100 could employ a wireless local area network (WLAN) access point (not shown) local to the client system 106 and the input device 112 and connected to the Internet, and wherein each of the client system 106 and the input device 112 establishes a separate wireless connection with the WLAN access point to independently communicate with the corresponding server 104 over the Internet via the WLAN access point.

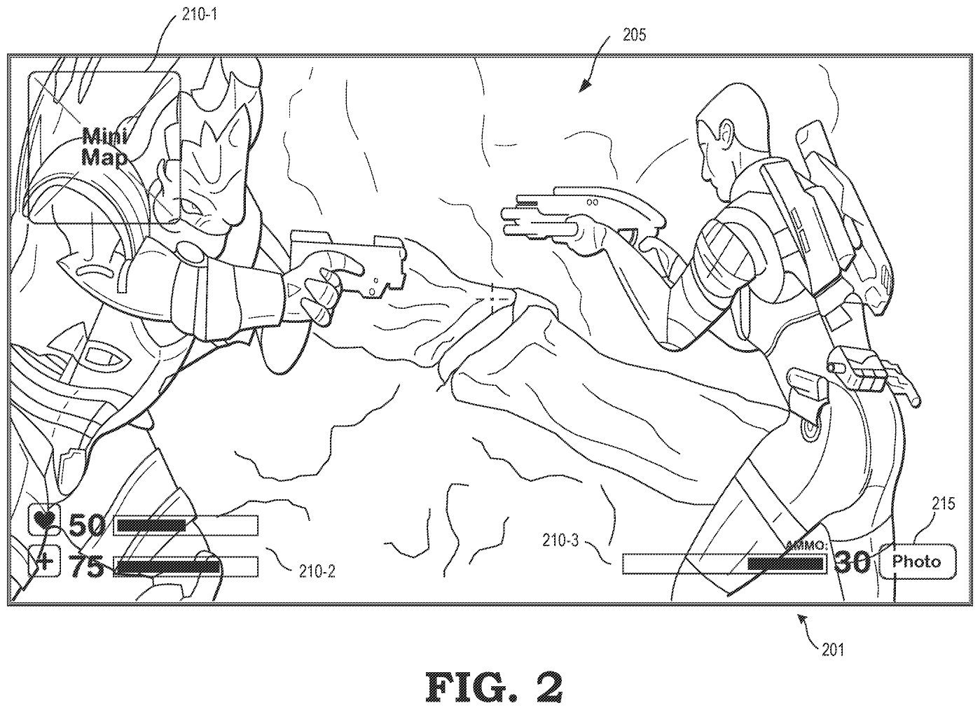

FIG. 2 illustrates an example gaming graphical user interface (GUI) 201 of a first game session, such as may be generated by one or more devices of a client system 106-1 of FIG. 1 as part of executing a gaming application (not shown) or, alternatively and with further reference to FIG. 1, provided to the client system 106 by a game streaming service operating one or more servers 104 that are executing the gaming application. In either case, the gaming GUI 201 comprises a portion of real-time gaming content displayed to a player as part of the game session. In the depicted embodiment, the gaming GUI 201 presents a game scene 205 as well as a variety of UI elements 210-1 (a map of the player's immediate surroundings in the virtual game world), 210-2 (graphical status indicators reflecting a current virtual health and virtual energy level of the player), and 210-3 (a graphical status indicator reflecting a current ammunition count of the player) that are each associated with operations of the gaming application in a first operational mode. During typical gameplay in the first operational mode, a player associated with the client system 106 traverses the game world and interacts with characters, objects, and/or other entities within that game world.

In the depicted embodiment, the gaming GUI 201 further includes mode control 215, enabling the player to effectively pause gaming operations in the first mode to initiate a second “photo” mode in order to capture one or more still images reflecting those first mode gaming operations. It will be appreciated that in various embodiments and scenarios, a gaming application, server, or client device may provide various facilities by which a player may initiate the second mode. As non-limiting examples, the second mode of operations may be initiated via player interaction with one or more user interface elements, menus, virtual or physical controls, or other facility by which the player may select to arrange and capture the one or more still images.

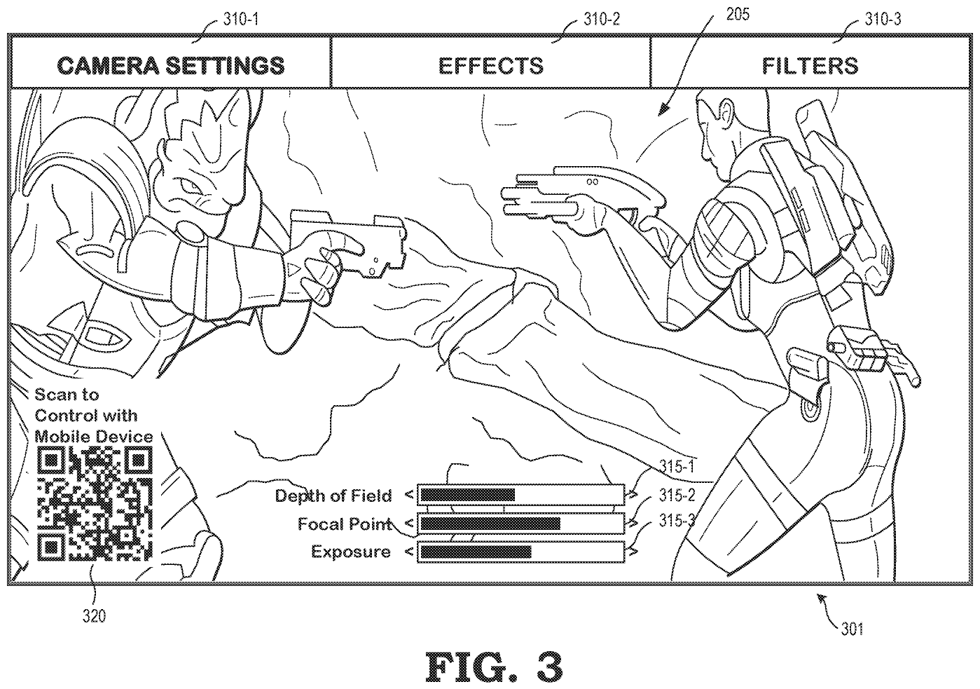

FIG. 3 depicts an example gaming GUI 301, such as may be presented to the player in response to selection of the mode control 215 in order to initiate the second “photo” mode of operation for the gaming application, and therefore to capture one or more still images from the gaming application in order to preserve images of gameplay for later retrieval and display. In particular, and with additional reference to FIG. 1, the gaming GUI 301 may be presented on the display 116 of the first gaming client device 110 as part of the game session after initiating operations in the second mode. In the depicted embodiment, the gaming GUI 301 includes the same game scene 205 as in the GUI 201 of FIG. 2. As part of initiating the second mode of operation, the game state has effectively been stopped in place, with the player able to adjust one or more photographic parameters and capture one or more still images from the gameplay without otherwise affecting that game state.

In the depicted embodiment, the player is provided with a number of user interface elements in order to adjust a variety of photographic parameters in the second mode of operation. In particular, the gaming GUI 301 now includes tab control sets 310-1 (“Camera Settings”), 310-2 (“Effects”), and 310-3 (“Filters”), each enabling the player to select a distinct subset of user interface elements. Currently, the first tab control set 310-1 “Camera Settings” is active, and is therefore displaying a variety of associated graphical range selection bars 315-1, 315-2, and 315-3, respectively providing controls for the player to choose a depth of field, focal point, and exposure for the still image to be captured. It will be appreciated that the particular user elements depicted are non-limiting examples, and that in various embodiments and scenarios, other UI elements may be provided for similar control over the still images to be captured in the second mode of operation.

The gaming GUI 301 further includes a user interface element 320, which in the depicted embodiment comprises a two-dimensional machine-readable optical label (a QR code) presented to facilitate initiation of the game session on a second gaming client device. In certain embodiments, the second gaming client device (such as gaming client device 120 of FIG. 1) may scan or otherwise capture the QR code (such as by an image capture facility of the second gaming client device) in order to retrieve and process a unique Uniform Resource Locator (URL) encoded via the QR code. Calling the unique URL may, for example, initiate a connection from the second gaming client device to a cloud gaming server (such as one of servers 104 of FIG. 1), which initiates the game session on the second gaming client device. In various embodiments, the unique URL may be based at least in part on a predefined user preferences associated with the player, with the first gaming client device, with the second gaming client device. In at least one embodiment, such predefined user preferences may be stored or retrieved by one or more servers executing the gaming application. As non-limiting examples, the predefined user preferences may include one or more parameters indicating an address or other identifier associated with the first or second gaming client devices; an address or other identifier associated with the player; an authentication scheme to be used for identifying the player and/or the first or second gaming client devices; etc.

In certain embodiments, retrieving and processing the encoded URL may cause the second gaming client device to present the real-time gaming content that is generated via the gaming application and presented on a display of the first gaming client device (such as the first gaming client device 110 of FIG. 1) to also be presented in real-time on a display of the second gaming client device. Thus, in at least one embodiment, initiating the game session on the second client device includes streaming (e.g., by one or more cloud gaming servers such as servers 104 of FIG. 1) the real-time gaming content associated with the game session to the second gaming client device while still streaming that real-time gaming content to the first gaming client device.

It will be appreciated that in certain embodiments, other machine-readable interface elements may be provided as part of the gaming GUI 301 in order to facilitate the initiation of the game session on the second gaming client device. As non-limiting examples, such machine-readable interface elements may include a one-dimensional barcode, a web address, an alphanumeric code, or any other machine-readable element that encodes the unique URL.

Once the game session has been initiated on the second gaming client device, the user of the second gaming client device may use control facilities of the second gaming client device to adjust one or more aspects of a virtual camera in the game world. As non-limiting examples, the user may move the second gaming client device in order to adjust a position of the virtual camera; may tilt or otherwise rotate the second gaming client device in order to adjust an orientation of the virtual camera; may interact with the second gaming client device, such as via one or more predefined gestures, in order to adjust a zoom parameter, depth of field parameter, focal point parameter, exposure or other parameters associated with the virtual camera; etc. Moreover, the user may interact with the second gaming client device to activate or control any of the user interface elements 310 and 315 of the gaming GUI 301, as well as to activate or control any additional user interface elements that may be provided via activation of the other tab control sets 310-2 and 310-3, and/or to initiate capture of one or more still images of the game scene 205 via the virtual camera and its adjusted parameters. It will be appreciated that a variety of interactions with the gaming application and game scene 205 may be implemented using the techniques described herein.

It will be appreciated that the GUIs and other information presented with respect to FIGS. 2-3 are included for illustrative purposes, and that such information and/or associated functionality may be presented or otherwise provided in other manners in other embodiments. In addition, it will be appreciated that GUIs and other information presented to users may vary with the type of client device used by the user, such as to present less information and/or functionality via client devices with smaller display screens and/or less ability to present information to or obtain input from the user, such as under control of a mobile application or gaming interface executing on the client device, or otherwise based on information sent to the client device from a cloud gaming server system and/or other gaming client device.

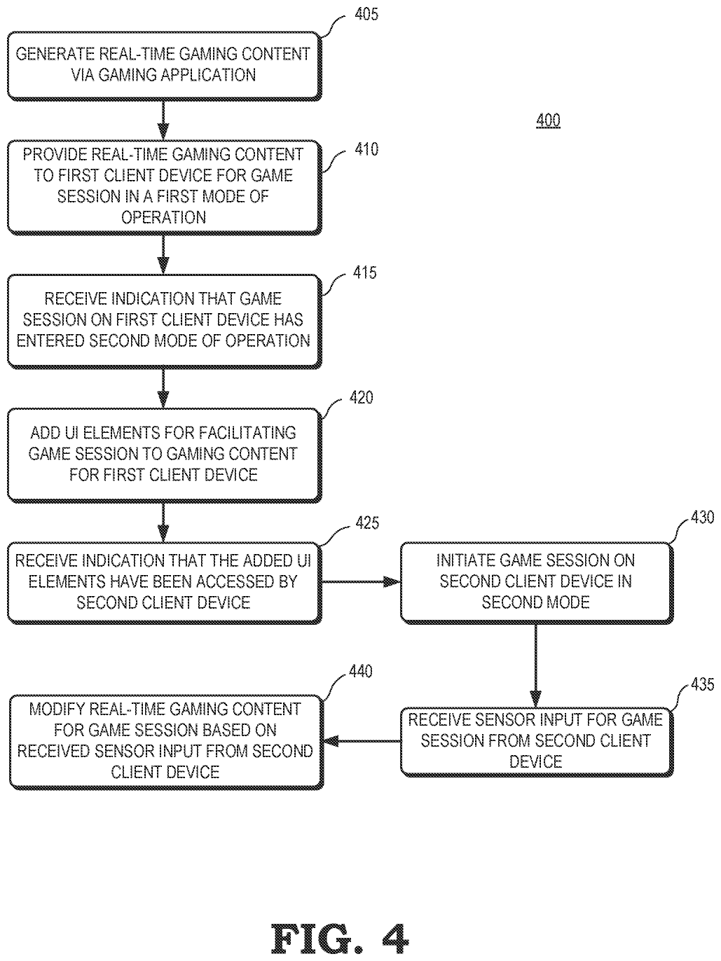

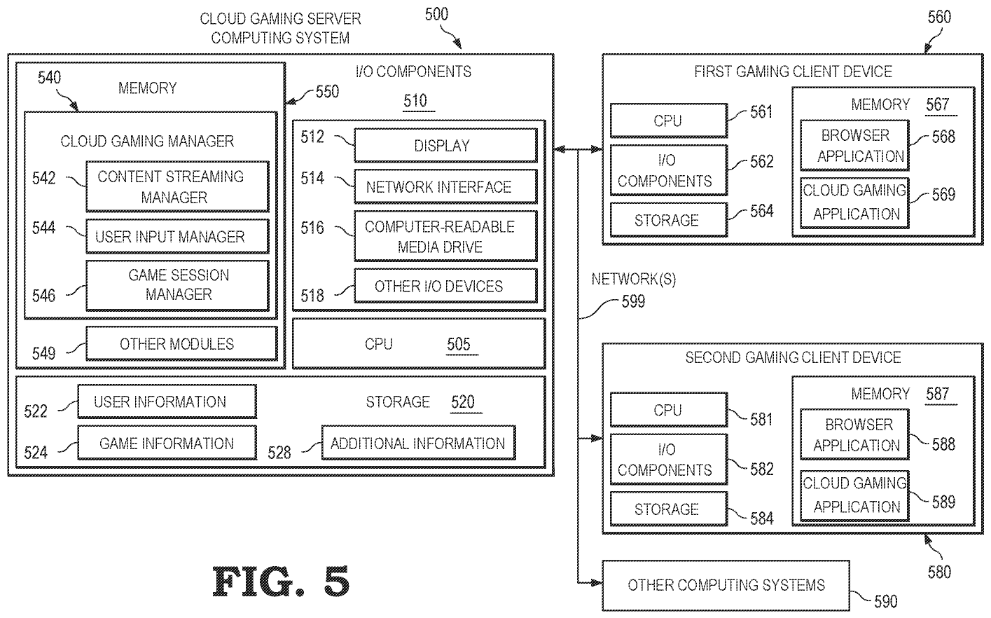

FIG. 4 is a block diagram illustrating an overview of an operational routine of a processor-based server system in accordance with one or more embodiments. The routine may be performed, for example, by one or more of the servers 104 of FIG. 1, by cloud gaming server computing system 500 of FIG. 5, or by some other embodiment.

The routine begins at block 405, in which the processor-based server system generates real-time gaming content for a first game session by executing a gaming application. The routine proceeds to block 410, in which the processor-based server system provides the real-time gaming content for the game session to a first gaming client device, such as client device 110 of FIG. 1, first gaming client device 560 of FIG. 5, or other client device. The routine then proceeds to block 415.

At block 415, the processor-based server system receives an indication that the game session on the first client device has initiated on the first gaming client device a second mode of operation, such as a photographic mode provided or supported by the gaming application being executed by the processor-based server system. Responsive to receiving that indication, the routine proceeds to block 420, in which the processor-based server system presents for display any UI elements associated with the second mode of the gaming application. In addition, the processor-based server system generates one or more additional UI elements (e.g., user interface elements 320 of FIG. 3 or other machine-readable optical label) for presentation via the first gaming client device in order to initiate the game session on a second gaming client device. The routine then proceeds to block 425.

At block 425, the processor-based server system receives an indication that the additional UI elements have been activated by a second gaming client device, such as by receiving an indication that the second gaming client device has accessed a unique URL encoded by or otherwise associated with the additional user interface elements. The routine then proceeds to block 430.

At block 430, the processor-based server system initiates the game session (operating in the second mode) on the second gaming client device. The routine then proceeds to block 435, in which the processor-based server system receives and processes sensor input for the game session from the second gaming client device (such as to adjust a position, orientation, and other parameters associated with a virtual camera), and then to block 440, in which the real-time gaming content generated for the game session based on input from the second gaming client device is provided to both the first and second gaming client devices. A user may now capture one or more images of the real-time gaming content using the second gaming client device, and in particular the parameters associated with the virtual camera as adjusted by the second gaming client device. Afterwards, the game session may be resumed in the first mode of operation on the first gaming client device.

FIG. 5 is a block diagram illustrating component-level functionality provided by a plurality of electronic circuits that, when in combined operation, are suitable for performing and configured to perform at least some of the techniques described herein. In the particular implementation depicted, the plurality of electronic circuits is at least partially housed within a cloud gaming server computing system 500 executing an implementation of a cloud gaming manager 540. The cloud gaming server computing system 500 includes one or more central processing units (“CPU”) or other processors 505, various input/output (“I/O”) components 510, storage 520, and memory 550, with the illustrated I/O components including a display 512, a network interface 514, a computer-readable media drive 516, and other I/O devices 518 (e.g., keyboards, mice or other pointing devices, microphones, speakers, GPS receivers, etc.). In various embodiments, one or more components of the cloud gaming server computing system 500 may be incorporated as or within one or more server computing systems to provide various types of gaming application output or other video content. It will be appreciated that an associated server computing device may include some components of the cloud gaming server computing system 500 as depicted, but not necessarily all of them. In a networked deployment, the cloud gaming server computing system 500 may operate in the capacity of a server machine, a client machine, or both in server-client network environments. In at least one example, the cloud gaming server computing system 500 may act as a peer system in peer-to-peer (P2P) (or other distributed) network environment. As such, the cloud gaming server computing system 500 may comprise a server computer, a personal computer (PC), a tablet PC, a set-top box (STB), a mobile computing device, a web appliance, a network router, switch or bridge, or any system capable of executing instructions (sequential or otherwise) that specify actions to be taken by that system. Further, while only a single computing system is illustrated, the term “system” shall also be taken to include any collection of systems that individually or jointly execute a set (or multiple sets) of instructions to perform any one or more of the methodologies discussed herein, such as cloud computing, software as a service (SaaS), or other computer cluster configurations.

The cloud gaming server computing system 500 and cloud gaming manager 540 may communicate with other computing systems, such as first gaming client device 560, second gaming client device 580, and other computing systems 590, via one or more networks 599 (e.g., the Internet, one or more cellular telephone networks, etc.). It will be appreciated that the first gaming client device 560, along with some or all of the second gaming client device 580 and other computing systems 590, may similarly include some or all of the types of components illustrated for cloud gaming server computing system 500 (e.g., to have a cloud gaming client application 569/589 respectively executing in memory 567 of the first gaming client device 560 or memory 587 of second gaming client device 580 in a manner analogous to the cloud gaming manager 540 executing in memory 550). In particular, the operations and functionality provided by CPU 561 and 581 may, in certain embodiments, be analogous to those of CPU 505; similarly, the operations and functionality provided by I/O components 562 and 582 may be analogous to those of I/O components 510, and the operations and functionality provided by storage components 564 and 584 may be analogous to those provided by storage 520. However, it will be appreciated that in various embodiments, various components may be available to one or more of the cloud gaming server computing system 500, the first gaming client device 560, and the second gaming client device 580 that are respectively unavailable to others of those devices. As one example, the I/O components 582 of the second gaming client device 580 may include a touchscreen input facility, and/or various accelerometer and gyroscopic sensors, that are not included within the analogous I/O components 510 of the cloud gaming server computing system 500 or the I/O components 562 of the first gaming client device five and 60. In the depicted embodiment, each of the gaming client devices 560 and 580 may interact with the cloud gaming server computing system 500, including to display real-time gaming content and provide indications of sensor inputs and/or other game inputs, via one or more of a respective dedicated cloud gaming application 569 and 589, and/or a browser application 568 and 588, executing in the respective memory of the respective gaming client device.

In the illustrated embodiment, an embodiment of the cloud gaming manager 540 executes in memory 550 in order to perform at least some of the described techniques, such as by using the processor(s) 505 to execute software instructions of the cloud gaming manager 540 in a manner that configures the processor(s) 505 and cloud gaming server computing system 500 to perform automated operations that implement those described techniques. As part of such automated operations, the cloud gaming manager 540 and/or other programs or modules 549 executing in memory 550 may store and/or retrieve various types of data, including in data structures of storage 520. In this example, the data used may include various types of user information in database (“DB”) 522, various types of game information (e.g., configuration information specific to and/or otherwise associated with one or more gaming applications, such as for use in handling aspects of photographic mode operations in those gaming applications) in DB 524, and/or various types of additional information 528, such as various analytical or other information related to one or more devices or services associated with the cloud gaming system.

It will be appreciated that the cloud gaming server computing system 500, as well as the other systems and devices included within FIG. 5, are merely illustrative and are not intended to limit the scope of the present disclosure. The systems and/or devices may instead each include multiple interacting computing systems or devices, and may be connected to other devices that are not specifically illustrated, including via Bluetooth communication or other direct communication, through one or more networks such as the Internet, via the Web, or via one or more private networks (e.g., mobile communication networks, etc.). More generally, a device or other computing system may comprise any combination of hardware that may interact and perform the described types of functionality, when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, biometric monitoring devices, digital music player devices, standalone or portable gaming devices, PDAs, wireless phones, Internet appliances, and various other consumer products that include appropriate communication capabilities. In addition, the functionality provided by the illustrated cloud gaming manager 540 may in some embodiments be distributed in various modules. Similarly, in some embodiments, some of the functionality of the cloud gaming manager 540 may not be provided and/or other additional functionality may be available. In addition, in certain implementations various functionality of the cloud gaming system may be provided by third-party partners of an operator of the cloud gaming system. For example, data collected by the cloud gaming system may be provided to a third party for analysis and/or metric generation.

It will also be appreciated that, while various items are illustrated as being stored in memory or on storage while being used, these items or portions of them may be transferred between memory and other storage devices for purposes of memory management and data integrity. Alternatively, in other embodiments some or all of the software modules and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., the cloud gaming manager 540 and/or cloud gaming application software executing on the first gaming client device 560 and/or the second gaming client device 580) and/or data structures, such as by execution of software instructions of the one or more software programs and/or by storage of such software instructions and/or data structures. Furthermore, in some embodiments, some or all of the systems and/or modules may be implemented or provided in other manners, such as by consisting of one or more means that are implemented at least partially in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, modules and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

Examples described herein may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The storage 520 may include one or more computer readable media on which is stored one or more sets of data structures or instructions (e.g., software) embodying or utilized by any one or more of the techniques or functions described herein. The instructions may also reside, completely or partially, within the memory 550 or within the CPU 505 during execution thereof by the cloud gaming server computing system 500. In an example, one or any combination of the hardware processor 505, the memory 550, or the storage 520 may constitute computer readable media.

The term “computer readable medium” may include a single medium or multiple media (e.g., a centralized or distributed database, and/or associated caches and servers) configured to store the one or more set of instructions, and may include any medium that is capable of storing, encoding, or carrying instructions for execution by the cloud gaming server computing system 500, the first gaming client device 560, and/or the second gaming client device 580, and that causes one or more of those computing systems and devices to respectively perform any one or more of the techniques of the present disclosure, or that is capable of storing, encoding or carrying data structures used by or associated with such instructions. Non-limiting computer readable medium examples may include solid-state memories, and optical and magnetic media. In an example, a massed computer readable medium comprises a computer readable medium with a plurality of particles having invariant (e.g., rest) mass. Accordingly, massed computer readable media are not transitory propagating signals. Specific examples of massed computer readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The stored one or more sets of data structures or instructions may further be transmitted or received over the networks 599 using a transmission medium via the network interface device 514 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 514 may include one or more physical jacks (e.g., Ethernet, coaxial, or phone jacks) or one or more antennas to connect to the networks 599. In an example, the network interface device 514 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the cloud gaming server computing system 500, and includes digital or analog communications signals or other intangible medium to facilitate communication of such software.

As used herein, the term “user” may refer to any human operator of a device or system described in the present disclosure. The term “selecting,” when used herein in relation to one or more elements of a graphical user interface or other electronic display, may include various user actions taken with respect to various input control devices depending on the client computing device used to interact with the display, such as one or more clicks using a mouse or other pointing device, one or more tapping interactions using a touch screen of a client device, etc. In addition, such selecting may additionally comprise interactions with various physical actuators capable of generating electrical or electronic signal as a result of such interactions. A nonexclusive list of examples of such actuators include electronic, mechanical or electromechanical implementations of keys, buttons, pressure plates, paddles, pedals, wheels, triggers, slides, touchpads, or other touch- or motion-sensitive element, and may be digital or analog in nature. Also as used herein, unless specifically disclaimed any notification, such as an indication of an audience input solicitation or other notification, may incorporate visual, auditory, haptic, or other information conveyed to a user.

As noted above, in some embodiments, certain aspects of the techniques described herein may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A computer-implemented method, comprising:
providing gaming content for a game session to a first client device associated with a user, the game session operating in a gaming mode;
receiving an indication that the first client device has requested the game session to enter a photo mode; and
based on the indication, initiating the game session on a second client device associated with the user, the game session on the second client device operating in the photo mode.

2. A computer-implemented method, comprising:
providing gaming content for a game session to a first client device associated with a user, the game session operating in a first mode of operation;
receiving an indication that the game session on the first client device has initiated a second mode of operation; and
based at least in part on the indicated initiation of the second mode, initiating the game session in the second mode on a second client device associated with the user.

3. The method of claim 2, further comprising providing, responsive to the game session initiating the second mode of operation, one or more interface elements in the game session on the first client device for connecting the second client device with the first client device and/or with a server streaming real-time content associated with the game session.

4. The method of claim 3, wherein the one or more interface elements include a first interface element to be photographically captured by the second client device.

5. The method of claim 4, wherein the first interface element is one or more of a group that includes a machine-readable optical label, a barcode, and a Quick Response (QR) code.

6. The method of claim 2, wherein providing the game session on the first client device includes streaming real-time content associated with the game session from one or more servers to the first client device, and wherein initiating the game session on the second client device includes streaming real-time content associated with the game session from the one or more servers to the second client device.

7. The method of claim 2, wherein the first mode comprises user gameplay via a gaming application, and wherein the second mode comprises a photographic mode for capturing one or more images from the user gameplay.

8. The method of claim 7, wherein operations in the second mode include adjusting one or more aspects of a virtual camera in a game world.

9. The method of claim 8, wherein, the one or more aspects include at least one of a group that includes a position of a virtual camera in the game world, an orientation of the virtual camera in the game world, and a lighting parameter for the virtual camera in the game world.

10. The method of claim 9, wherein adjusting the one or more aspects of the virtual camera includes adjusting the position of the virtual camera based on a position of the second client device.

11. The method of claim 9, wherein adjusting the one or more aspects of the virtual camera includes adjusting the orientation of the virtual camera based on an orientation of the second client device.

12. The method of claim 2, wherein initiating the game session on the second client device includes presenting content generated via the gaming application that is being displayed on a display of the first client device on a display of the second client device.

13. A server, comprising:
a network interface;
one or more processors; and
a memory storing a set of executable instructions, the set of executable instructions to manipulate the one or more processors to:
provide gaming content for a game session to a first client device associated with a user, the game session operating in a first mode of operation;
receive an indication that the game session on the first client device has initiated a second mode of operation; and
based at least in part on the indicated initiation of the second mode, initiate the game session in the second mode on a second client device associated with the user.

14. The server of claim 13, wherein the set of executable instructions are further to manipulate the one or more processors to provide, responsive to the game session initiating the second mode of operation, one or more interface elements in the game session on the first client device for connecting the second client device with the first client device and/or with the server.

15. The server of claim 14, wherein the one or more interface elements include a first interface element to be photographically captured by the second client device.

16. The server of claim 15, wherein the first interface element is one or more of a group that includes a machine-readable optical label, a barcode, and a Quick Response (QR) code.

17. The server of claim 13, wherein to provide the game session on the first client device includes to stream real-time content associated with the game session from the server to the first client device, and wherein to initiate the game session on the second client device includes to stream the real-time content from the server to the second client device.

18. The server of claim 13, wherein the first mode comprises user gameplay via a gaming application, and wherein the second mode comprises a photographic mode for capturing one or more images from the user gameplay.

19. The server of claim 18, wherein operations in the second mode include to adjust one or more aspects of a virtual camera in a game world.

20. The server of claim 19, wherein the one or more aspects comprise at least one of a group that includes a position of a virtual camera in the game world, an orientation of the virtual camera in the game world, and a lighting parameter for the virtual camera in the game world.

21. The server of claim 19, wherein to adjust the one or more aspects of the virtual camera includes to adjust a position of the virtual camera based on a position of the second client device.

22. The server of claim 19, wherein to adjust one or more aspects of the virtual camera includes to adjust an orientation of the virtual camera based on an orientation of the second client device.

23. (canceled)
